(19) United States
(12) Patent Application Publication
(10) Pub. No.: US 2008/0008321 A1
(43) Pub. Date: Jan. 10, 2008

(54) Conditional access enhancements using an always-on satellite backchannel link

(75) Inventors: Gregory J. Gagnon, Redondo Beach, CA (US); Ronald P. Cocchi, Seal Beach, CA (US); Dennis R. Flaharty, Irvine, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: SypherMedia International, Inc.

(21) Appl. No.: 11/483,909

(22) Filed: Jul. 10, 2006

(51) Int. Cl. H04K 1/00

(52) U.S. Cl. 380/270

(57) ABSTRACT

A method and apparatus for providing conditional access to media programs is disclosed. An embodiment of the method comprises the steps of generating a validation message in at least one of the receiver stations, the validation message comprising an answer to a validation query; transmitting the validation message directly from the receiver to the satellite on an always-on backchannel communications link; and receiving the media programs from the satellite only if the validation message matches an expected validation message.

### CROSS-REFERENCE TO RELATED APPLICATIONS

This application is related to the following applications, each of which are incorporated by reference herein:

U.S. Patent Application US2005/037197, by Ronald P. Cocchi, Gregory J. Gagnon, and Dennis R. Flaharty, filed Oct. 18, 2005 and entitled METHOD AND APPARATUS FOR SUPPORTING MULTIPLE BROADCASTERS INDEPENDENTLY USING A SINGLE CONDITIONAL ACCESS SYSTEM,” which claims benefit of U.S. Provisional Patent Application No. 60/619,663, entitled “METHOD OF SUPPORTING MULTIPLE BROADCASTERS INDEPENDENTLY USING A SINGLE CONDITIONAL ACCESS SYSTEM,” by Ronald P. Cocchi, Gregory J. Gagnon, and Dennis R. Flaharty, filed Oct. 18, 2004; and

U.S. patent application Ser. No. 11/441,888, by Ronald P. Cocchi and Frances C. McKee-Clabaugh, filed May 26, 2006 and entitled “METHOD AND APPARATUS FOR SUPPORTING BROADCAST EFFICIENCY AND SECURITY ENHANCEMENTS.”

### BACKGROUND OF THE INVENTION

1. Field of the Invention

The present invention relates to systems and methods for providing conditional access to media programs, and in particular to a system and method for providing for conditional access enhancements using an always-on backchannel link.

2. Description of the Related Art

For many years, media programs such as television and radio programs have been broadcast to viewers/listeners free of charge. More recently, this free-of-charge dissemination model has been augmented with a fee-for-service and/or fee-for-view model in which paying subscribers are provided access to a greater variety and number of media programs, including video programs, audio programs and the like, by cable, satellite and terrestrial broadcasts.

However, while subscriber-based services are readily available in some areas, they are not available on a worldwide basis. Further, in current media program subscription business models, subscribers are typically offered services from a small number of providers (e.g. DIRECTV or ECHOSTAR, or the approved local cable provider) each of which typically provide a large number of media channels from a variety of sources (e.g. ESPN, HBO, COURT TV, HISTORY CHANNEL). To assure that only subscribers receive the media programs, each service provider typically encrypts the program material and provides equipment necessary for the customer to decrypt them so that they can be viewed.

One of the roadblocks to the evolution of such services is the means by which the service provider assures that only paying customers receive their media programs. Existing conditional access systems were initially developed for small markets and grew to larger markets over a long period of time. This growth has attributed to the success of the pay TV industry but has come at some cost to the conditional access infrastructure.

For example, in order that the subscriber be charged for receiving media programs, and in particular, pay TV services, the conditional access system must include some means for returning information (such as pay TV billing information) to the headed. Current conditional access systems use the public switched telephone network (PSTN) for a backchannel to return this information. However, this implementation requires subscribers to connect a telephone line (e.g. RJ-11 plug) to their set top box (STB). This increases the cost and complexity of the installation, because phone sockets are typically not provided in the same living spaces as subscribers customarily place their televisions and STBs. Customers are also increasingly unwilling to connect their STB to the phone line. For some, this unwillingness may have its roots in privacy-related concerns, but for others, this unwillingness is rooted in a desire to avoid paying for pay TV services. Also, many subscribers no longer have PSTN service in their homes, choosing to rely on cellphones or voice over Internet protocol (VOIP) systems.

A conditional access system is needed that provides subscriber information to the headend in a way that is harder to defeat, easier to install, and one that permits a wide variety of security enhancing techniques without significantly increasing cost.

### SUMMARY OF THE INVENTION

To address the requirements described above, the present invention discloses a method, apparatus, article of manufacture for providing conditional access to media programs. In one embodiment, the invention is manifested by a method for preventing fraudulent reception of media programs transmitted by a satellite via a forward channel link to a plurality of receiver stations. The method comprises the steps of generating a validation message in at least one of the receiver stations, the validation message comprising an answer to a validation query; transmitting the validation message directly from the receiver to the satellite on an always-on backchannel communications link; and receiving the media programs from the satellite only if the validation message matches an expected validation message. In another embodiment, the invention is manifested by a receiver station for preventing fraudulent reception of media programs transmitted by a satellite via a forward channel link. The receiver station comprises an uplink antenna, a downlink antenna, and a receiver. The receiver comprises a processor for generating a validation message, the validation message comprising an answer to a validation query; a transmitter subsystem, coupled to the uplink antenna and the processor, the transmitter subsystem for transmitting the validation message directly from the receiver to the satellite on an always-on backchannel communications link; and a receiver subsystem, coupled to the downlink antenna and the processor, the receiver subsystem for receiving the media programs from the satellite only if the validation message matches an expected validation message.

The foregoing uses an always-on backchannel as the return path in what were otherwise traditional one-way satellite architectures to greatly strengthen the security of the broadcast architecture. Unlike intermittently connected dial-up systems, the backchannel can be used to transmit security-related information back to the headend at any time, and much more frequently than is currently possible. Such information can even be provided on a continuous basis, if desired. The system thus lowers the broadcaster's operational costs because the monthly phone call via the STB is no longer required.

### BRIEF DESCRIPTION OF THE DRAWINGS

Referring now to the drawings in which like reference numbers represent corresponding parts throughout:

FIG. 1 is a diagram illustrating a media program distribution system;

FIGS. 2A and 2B are diagrams of a representative data stream and the packets produced by the media program distribution system;

FIG. 2C is a diagram of a typical subscriber station;

FIG. 3 is a diagram illustrating how a conditional access module decrypts an encrypted control word;

FIG. 4 is a diagram of one embodiment of a conditional access system;

FIGS. 5A and 5B are diagrams of one embodiment of a downlink antenna;

FIGS. 6A and 6B are diagrams of one embodiment of an integrated uplink/downlink antenna;

FIG. 7 is a diagram of depicting one technique for preventing fraudulent reception of media programs using always-on backchannel messaging; and

FIG. 8 illustrates an exemplary computer system 800 that could be used to implement the present invention.

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

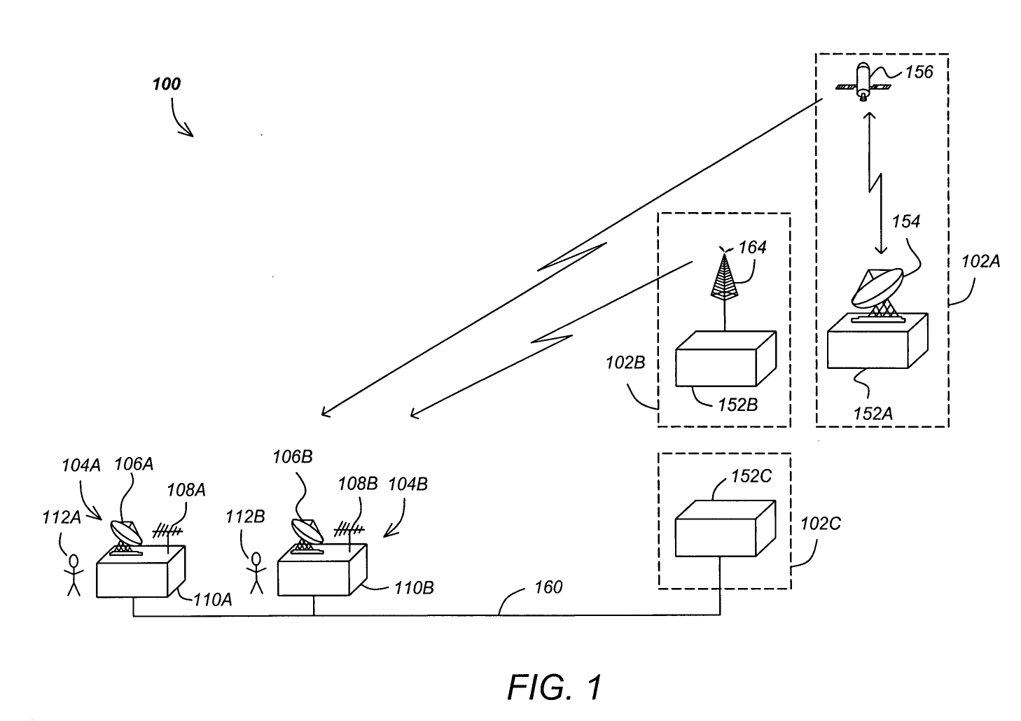

FIG. 1 is a diagram illustrating a media program distribution system 100. The system 100 includes a plurality of service providers (hereinafter alternatively referred to as broadcasters) 102, including a first service provider 102A that broadcasts media programs from a satellite broadcast facility 152A via one or more uplink antennas 154 and one or more satellites 156, a second service provider 102B, that broadcasts media programs from terrestrial broadcast facility 152B and one or more terrestrial antennas 164, and a third service provider 102C that broadcasts media programs from cable broadcast facility 152C via a cable link 160.

The system 100 also comprises a plurality of subscriber stations 104A, 104B (alternatively referred to hereinafter as subscriber station(s) or receiving station(s) 104), each providing service to one or more subscribers 112A and 112B (alternatively referred to hereinafter as subscribers 112). Each subscriber station 104A, 104B may include a satellite reception antenna 106A, 106B (alternatively referred to hereinafter as satellite reception antenna 106) and/or a terrestrial broadcast antenna 108A, 108B (alternatively referred to hereinafter as terrestrial broadcast antenna 108) communicatively coupled to a receiver 110A, 110B (alternatively referred to hereinafter as receiver(s) 110, set top box(es) (STBs), or integrated receiver/decoder(s) (IRDs)).

### Broadcast Data Stream Format and Protocol

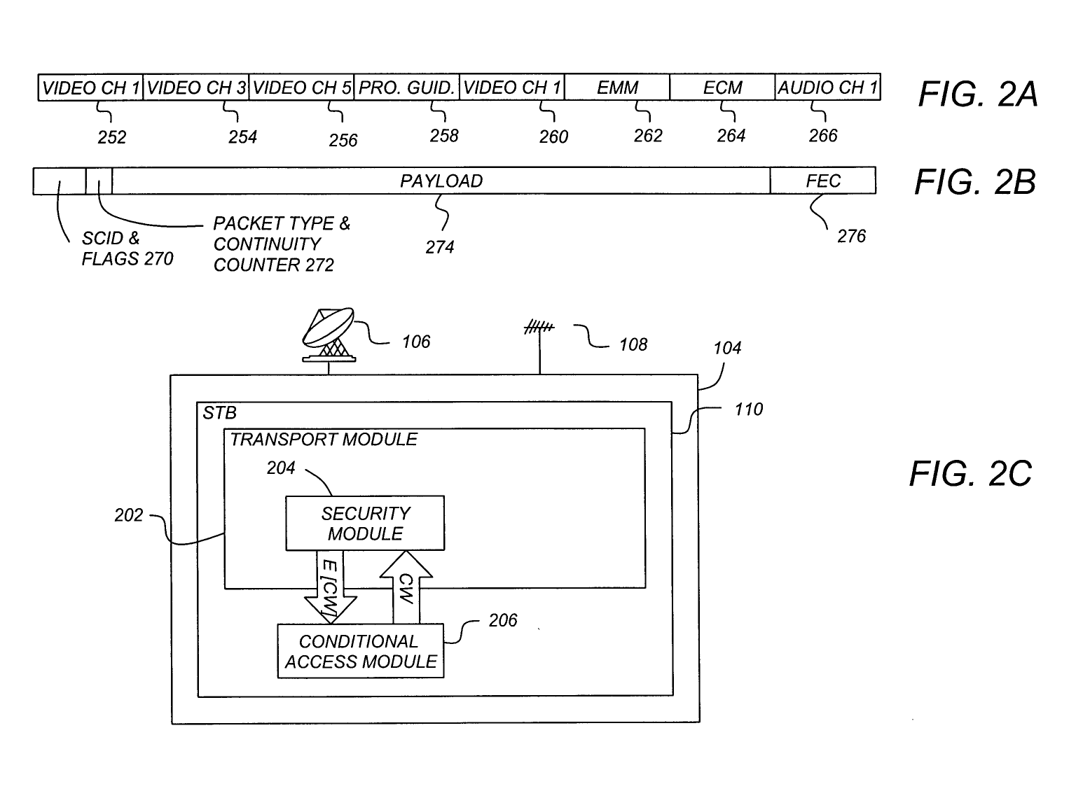

FIG. 2A is a diagram of a representative data stream. The data stream comprises a plurality of packets combined by time division multiple access (D MA) techniques, with each packet identified by a system channel identifier or SCID.

The first packet segment 252 comprises information from a first video channel (for a first media program). Packet segment 254 comprises information relevant for a second video channel (for a second media program). Packet segment 256 comprises information from video channel 5 (for yet another media program). Packet segment 258 comprises program guide information such as the information provided by the program guide subsystem. Packet 260 comprises additional first media channel information. Packet 262 includes an entitlement management message (EMM) 262, which carries entitlement management information that is used by the receiving station 104 to determine whether the user is permitted to view or record media programs on one or more of the media channels, as described further below. Packet 266 includes the audio information for the media program transmitted on video channel 1. The data stream includes a packet with an entitlement control message (ECM) 264. The ECM is also used to determine whether the user is permitted to view or record the media programs on the media channels, as described below.

The data stream therefore comprises a series of TDMA packets from a number of data sources. The data stream is modulated and transmitted on a frequency band to the satellite via the antenna 154. The receiving station 104 receives these signals via the antenna 106, and using the system channel identifier (SCID) described below, reassembles the packets to regenerate the program material for each of the channels.

FIG. 2B is a diagram of a data packet. Each data packet (e.g. 252-266) comprises a number of packet segments. The first packet segment 270 comprises two bytes of information containing the SCID and flags. The SCID is a unique 12-bit number that uniquely identifies the data packet's data channel. The data channel includes the information that is required to reproduce the media program at the receiver station. For example, since the video for channel 1 is in packets 252 and 260 of the data stream, and the audio for channel 1 is in packet 266, each of these packets will have the same SCID. Also, although the EMM transmits entitlement information related to more than one media program, the ECM typically includes information relating to only one media program and is transmitted with the same stream as the media program as well.

The flags include 4 bits that are used to control other features. The second packet segment 272 is made up of a 4-bit packet type indicator. The packet type identifies the packet by data type (video, audio, ECM, etc.). When combined with the SCID, the packet type determines how the data packet will be used. The next packet segment 274 comprises 127 bytes of payload data, which in the cases of packets 252 is a portion of the video program provided by the video program source. The final packet segment 276 is data required to perform forward error correction.

FIG. 2C is a diagram of a typical subscriber station 104. Each station 104 includes at least one receiver or STB 110, which itself includes a transport module 202 that communicates with a conditional access module (CAM) 206. In one embodiment, the CAM 206 is a smart card that is removably communicatively coupleable to the transport module 202 and hence, the STB 110. In another embodiment, the CAM 206 is a device such as a chip or a collection of devices that are physically integrated with the STB 110 and irremovable. To assure that only those who subscribe to the service are provided with media programs, the service providers typically encrypt the media program M with a control word CW, thus producing and encrypted program E_{CW}[M], and transmit the encrypted media program E_{CW}[M] and an encrypted version of the control word E_{K}[CWᵢ] to the receiver 110. The receiver 110 receives both the encrypted program E_{CW}[M] and the encrypted control word E_{K}[CWᵢ]. The transport module 202 analyzes the incoming data stream and passes the encrypted control word E_{K}[CWᵢ] to the CAM 206, which decrypts the control word CWᵢ and returns the decrypted control word CWᵢ to a security module 204 or similar device in the transport module 202. The security module 204 then uses the control word CWᵢ to decrypt the encrypted media program E_{CW}[M] to produce the media program M for presentation to the subscriber. This system assures that only those who are in possession of a valid CAM 206 can receive and decode media programs. However, it does not prevent the use of the CAM 206 in any other STB 110. Hence, if the CAM 206 is compromised or duplicated, unauthorized access to media programs is possible.

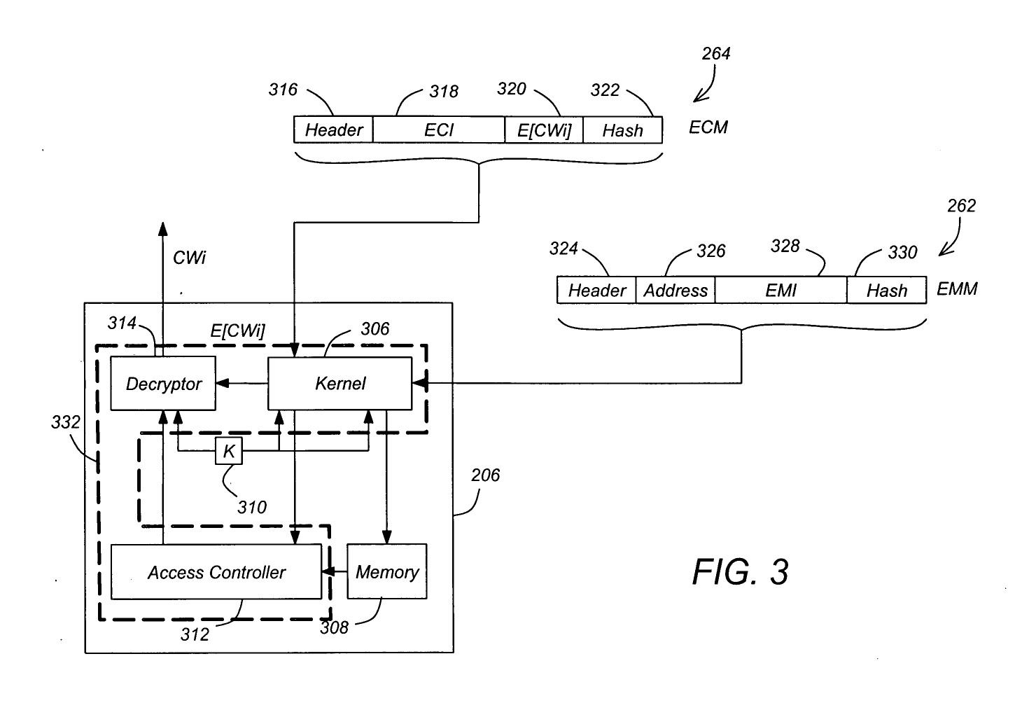

FIG. 3 is a diagram illustrating further details regarding how the CAM 206 decrypts the encrypted control word E_{K}[CWᵢ]. Entitlement control information (ECI) 318 and entitlement management information (EMI) 328 are provided to the CAM 206 in an entitlement control message (ECM) 264 and an entitlement management message EMM) 262, respectively. Typically, the ECM 264 and the EMM 262 are transmitted by the broadcaster or media program provider 102, in a single data stream, but separate packages and received by the STB or receiver 110. The ECM 264 typically comprises a header 316, ECI 318, an encrypted control word E_{K}[CWᵢ] 320 and a hash value 322. The EMM 262 typically comprises a header 324, an address 326, EMI 328 that defines what services or programs the subscriber is permitted access to, and a hash value 330.

In one embodiment, the ECM 264 and EMM 262 is provided to a kernel 306 for authentication purposes before further use. Authentication can be accomplished in a number of ways. For example, the ECM 264 may include a hash 322 of the access conditions 318, generated using the same key (K) that is used to encrypt the control word (CW). In this case, the kernel 306 uses the locally stored key (K) 310 to compute a hash of the access conditions 318, and compares the result with the hash 322 value in the ECM 264. If the computed and recited hash compare favorably, the access conditions 318 are verified, and the ECM 264 is authenticated for use. The same technique can be used to verify the encrypted control word E_{K}[CWᵢ] 320 and the access information 328 as well (e.g. by comparison of the hash 330 received in the EMM 262 and a hash computed using the key 310).

Although FIG. 3 illustrates a single kernel 306, the ECM 264 and the EMM 262 can be verified by different verifiers, and using different keys if desired. Also, the access controller 312, kernel 306 and decryptor 314 may be implemented by a single processor 332 or different, perhaps special purpose processors. Once verified, the access information 328 from the EMM 262 is stored in storage 308 and made available to the access controller 312.

In another embodiment, the control word CWᵢ and the access control information 318 can be encrypted according to the key (K) (resulting in E_{K}[CWᵢ+ACI] or E_{K}[CWᵢ] and E_{K}[ACI]). In this case, the access control information ACI is decrypted by the decryptor 314, sent to the access controller 312 where it is compared to the entitlement management information stored in memory 308. If the comparison indicates that the media program should be made available to the subscriber, the access controller instructs the decryptor 314 to decrypt the encrypted control word E_{K}[CWᵢ] to produce the control word CWᵢ, and the control word CWᵢ is used to decrypt the media program.

The access controller 312 compares the access condition information 318 with the access entitlement information 328 to determine if the subscriber should have access to the media program that was encrypted with the control word CWᵢ. If so, the access controller 312 instructs the decryptor 314 to decrypt the encrypted control word E_{K}[CWᵢ] using key 310 to produce the control word CWᵢ. The STB 110 uses the control word to decrypt the media program.

One of the significant challenges facing traditional conditional access systems used in a satellite broadcast environment is how to get a return channel from the STB 110 in the consumer's home to the broadcaster. If available, this return channel (or backchannel) could be used for “callback” information such as reporting Pay Per View (PPV) type information, reporting the status of the STB 110 and CAM 206, and real time service validation and authentication with the headend.

Traditionally, this callback activity used a standard phone line connection to the STB 110, which included a telephone modem. After a specific trigger event (e.g. a prescribed monthly time, cost limit being reached, or number of pay programs watched), the STB 110 called a prescribed number to contact the broadcaster segment 401 and transmit its necessary information to the back office for billing purposes.

Unfortunately for standard household installations, either there is not a phone line outlet available near where the television and STB 110 are installed or there is a reluctance of the customer to connect the STB 110 to the phone line. This can substantially increase the amount of time and money required to install the STB 110.

Also, even if the STB 110 is connected to a phone line, there may be transmission issues with the callback due to noise on the line or the phone switching mechanisms. Consequently, typically only ten to twenty percent deployed STBs 110 successfully make a callback on a monthly basis. This substantially limits the broadcaster's ability to collect revenue from the customers or to limit the provision of media programs to legitimate subscribers, both of which negatively affect the broadcaster's revenues.

An alternative apparatus and method for providing callback mechanism is described below which allows the broadcaster to collect revenues from subscribers and to limit provision of media programs to legitimate subscribers. The apparatus and method relies on a secure, reliable and always-on backchannel, that allows the broadcaster to change current PPV paradigms by charging one fee for a first viewing of a PPV event and then lower fees for subsequent viewings. If desired, a price structure can be implemented wherein the fee for each subsequent viewing is lower than the preceding viewing. The always-on backchannel is also used to implement increased security measures to frustrate hackers and to prevent fraud.

Real-Time Authentication: For standard satellite-based conditional access systems using satellite architectures, it is not possible to determine if a subscriber's Smart Card is authentic or if they are illegally receiving the signal through some type of hacking/piracy activity in the card. However, in one embodiment of the conditional access system uses the always-on backchannel authenticate and interrogate the STB 110 or CAM 206, or STB/CAM pairing (even if such pairing is performed autonomously by the STB/CAM), by returning information from the STB/CAM that confirms that the approved CAM 206 and service authorization is being used with the STB 110.

Real-Time Validation: For standard satellite-based, PSTN callback conditional access systems, it is not feasible to validate subscriber's viewing rights. One embodiment of the conditional access system uses the always-on backchannel to verify viewing rights on a frequent or continual basis. The verification of such rights can also be performed on a per-channel or per-STB basis. These capabilities are not available in a conventional conditional access system using PSTN callback because of callback costs, bandwidth limitations, and PSTN conflicts. For example, PSTN callbacks are typically performed at early hours of the morning, when the subscriber's telephone will presumably be unused. The use of the always-on backchannel described herein is not subject to these limitations.

Tamper Detection/Fraud Prevention: For standard satellite-based PSTN callback conditional access systems, the possessor of the STB 110 can prevent the return of information by merely unplugging the STB 110 from the phone jack. The availability of an always-on backchannel allows the conditional access system to interrogate the STB 110 or the CAM 206 to detect tampering. In one embodiment, the STB 110 and/or CAM 206 are configured (e.g. by suitable programming) to use the always-on backchannel to return messages to the broadcaster segment to provide information that can be used to identify or troubleshoot a problem with the STB 110 or CAM 206. This not only improves customer service, it also improves the overall reliability of STBs/CAMs currently deployed, and the information can be used to improve the reliability of STBs/CAMs that have yet to be deployed. Security paradigms can be adopted and changed frequently, if desired.

In another embodiment of conditional access system, CAMs 206 are programmed to offer limited lifetime functionality, with any extension of these lifetimes contingent upon receiving information on the backchannel.

CAMless Conditional Access System: In many respects, the weak point with current conditional access systems is their reliance on a CAM 206 removable from the STB 110 to perform billing operations and to store and collect billing information. That is because CAMs 206 perform many of the operations required to implement conditional access, and yet remain subject to hacking. The use of an always-on backchannel allows much or all of the security and pay-per-view processing to be performed by the broadcaster segment with authentication being performed in real time or near real time.

CAM Lifetime Extension: CAMs 206 typically have a design lifetime of approximately 4 to 6 years, yet, because security features need to be updated often to stay ahead of at least the substantial majority of hackers, the security of a CAM 206 is typically only about 1 to 3 years. One embodiment of the conditional access system narrows this disparity by providing in-field renewability by downloading the updated software. While this feature has been available in the past, the always-on backchannel provides substantial advantages. First, the updated software can be verified immediately after the download, reducing the time during which a hacker might obtain access to the new code. Second, the backchannel can be used to support two-way upgrading . . . that is, to report the successful downloading of the code and to make a coded request for a key to unlock and use the software, and optionally, to pair the CAM 206 with the STB 110. While obtaining a key is theoretically possible with a PSTN callback system, these operations must either be performed at limited times of the day (e.g. when the PSTN line is not likely to be used) or there must be a substantial delay before the software is verified and used.

The always-on backchannel can be used to implement other features as well, including targeted advertisements and/or interactive services including advertisements, text messaging, gaming, stock, weather, sports scores, and news. It can also be used as a low-bandwidth link in a very small satellite (VSAT) system.

### System Architecture

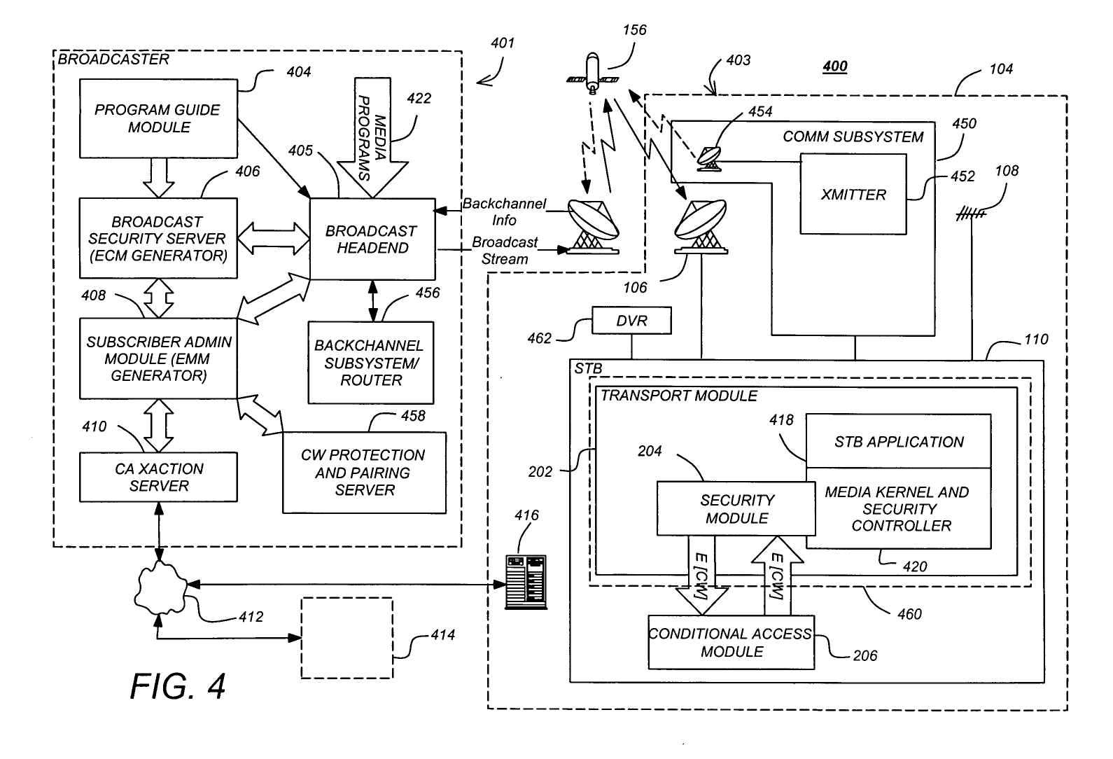

FIG. 4 is a diagram of one embodiment of a conditional access system 400. The conditional access system 400 is used to controllably generate and transmit the EMM 262 and the ECM 264 to the receiving stations 104 so that the media programs may be accessed and viewed by approved subscribers. The conditional access system 400 includes a broadcaster segment 401 and a receiver segment 403.

The broadcaster segment 401 includes a broadcast headend 405 that is communicatively coupled to a program guide module 404, a broadcast security server 406, and a subscriber administration module 408 to control subscriber 112 access to the media programs 422.

The subscriber administration module (SAM) 408 generates a service bitmap and provides it to the broadcast headend 405 for assembly into the broadcast data stream transmitted to the receiver station 104. The SAM 408 also controls the rate at which EMMs 262 are inserted into the broadcast stream. The SAM 408 also adds, deletes, and modifies authorized programming for the subscriber 112, controls the subscriptions, and handles service renewal requests. Subscriptions include pay-per-view events such as order ahead pay-per-view (OPPV) and impulse pay-per-view (IPPV) events. Unlike OPPV events, IPPV events do not require transmission of individual authorization messages.

The broadcast security server (BSS) 406 generates the ECM 264, and performs the hashing, combining, and/or encrypting operations required to generate both the EMM 262 and the ECM 264.

The broadcaster segment 401 transmits EMM 262 and ECM 264 messages to the receiver segment 403 to the STB application 418 and media kernel/security controller 420, where processing is performed to determine which services should be provided to the subscriber 112.

The broadcaster segment 401 also includes a backchannel subsystem 456 in communication with the broadcast headend 405, and a control word protection and pairing server 458 in communication with the subscriber administration module 408. The backchannel subsystem 456 generates and receives backchannel messages, and routes and/or acts on the received messages as appropriate. For example, in one embodiment, the backchannel subsystem 456 generates cryptographic challenges to be transmitted to the STB 110, receives STB or CAM-generated responses to those cryptographic challenges, and takes appropriate action to permit or deny conditional access to the media programs based on the response (or commands other modules in the broadcaster segment 401 to do so). Such appropriate response may include, for example, a message to disable the STB 110, a new set of processor instructions to be downloaded in the STB's memory, a message enabling the STB 110 to receive selected programs, or messages responding to a message from a consumer application (gaming, text messaging) operating at the receiver station 104 transmitted via the backchannel.

The subscriber administration module 408 also interacts with the CW protection and pairing server to assure that the pairing between the STB 110 and the CAM 206 is properly maintained. In other words, the information received by the broadcaster segment 401 via the backchannel is handled by the backchannel subsystem 456 and provided to the CW protection and pairing server 458 via the broadcast headend 405 and the subscriber administration module 408.

The receiver segment 403 includes a receiver station 104 having a receiver/STB 110. The STB 110 includes a transport module 202, which handles the flow of the received broadcast data stream within the STB 110. The transport module 202 also includes an STB application 418 interfacing with a conditional access module 206 via a media kernel 420 and a security module 204. In one embodiment, the conditional access module 206 is a smart card having a security chip that can be removably inserted into the STB 110. The transport module 202, STB application 418, media kernel 420, and security module 204 are typically implemented by a receiver processor 460 having a coupled or integrated memory with instructions for performing the operations of these modules. Each of the transport module 202, STB application 418, media kernel 420 and security module 204 may also be implemented by separate special purpose processors executing instructions stored in local or remote memories.

The conditional access module 206 uses the EMM 262 and ECM 264 to limit media program access to subscribers. While the media kernel/security controller 420 and STB application 418 are illustrated as being part of the transport module 202, they may be incorporated into the conditional access module 206 or any part of the STB 110.

Users may subscribe to the media service by providing STB 110 identifying information to the conditional access system 400. This can be accomplished via a computer 416 at the receiver station 104. In one embodiment, the user uses an Internet browser executing on the computer 416 to enter STB 110 identifying information. The information is transmitted to the broadcaster 102 via the Internet 412. This can also be accomplished by calling a broadcaster customer service representative, or by any other means known in the art. Web-based authorization is the preferred method of accepting service requests because it requires little or no human intervention between the transaction server 410 and the subscriber 112.

The subscriber 112 can subscribe to a wide variety of services, including ordinary subscription services, pay-per-view (PPV) media programs, select any order ahead pay-per-view (OPPV) media programs, and impulse pay-per-view (IPPV) media programs. Billing for those services can be accomplished via a third party 414 such as PAYPAL or a credit card agency. The subscriber 112 can also pre-authorize a credit that can be sent to the conditional access module 206. The subscriber 112 can repeat this process for each media program or group of media programs that they would like to receive.

The conditional access transaction server 410 accepts this information and initiates activation of the service by providing the information to the subscriber administration module 408. An activation component controls the activation of the conditional access module 206/STB 110 pairs, and keeps track of such pairings to assure integrity.

The STB 110 also comprises a communications subsystem 450 having an uplink transmitter subsystem 452 and an uplink antenna 454. The communications subsystem 450 implement backchannel communications between the STB 110 and the broadcaster segment 401.

Although the communications subsystem 450 is shown as a part of the receiver station 104 and separate from the STB 110, some or all of the communications subsystem 450 can be implemented in the STB 110, or in the antenna 106. For example, the uplink transmitter 452 can be integrated with the STB 110, and the uplink antenna 454 can be integrated with downlink antenna 106.

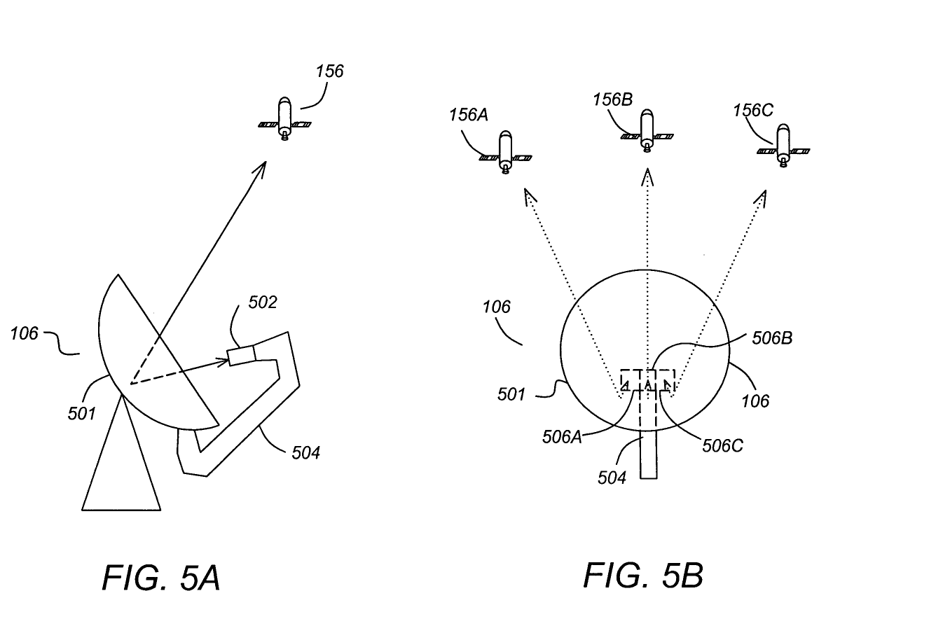

FIGS. 5A and 5B are diagrams of one embodiment of a downlink antenna 106. The downlink antenna 106 comprises a feed 502 having one or more low noise block converters (LNBs) 506A-506C that respectively sense radio frequency (RF) energy that is transmitted by the satellites 156A-156C and reflected by the reflector 501 and convert that RF energy into a form usable by the STB 110. The multiple LNBs 506A-506C allow signals to be received from different satellites by electronically switching between LNBs.

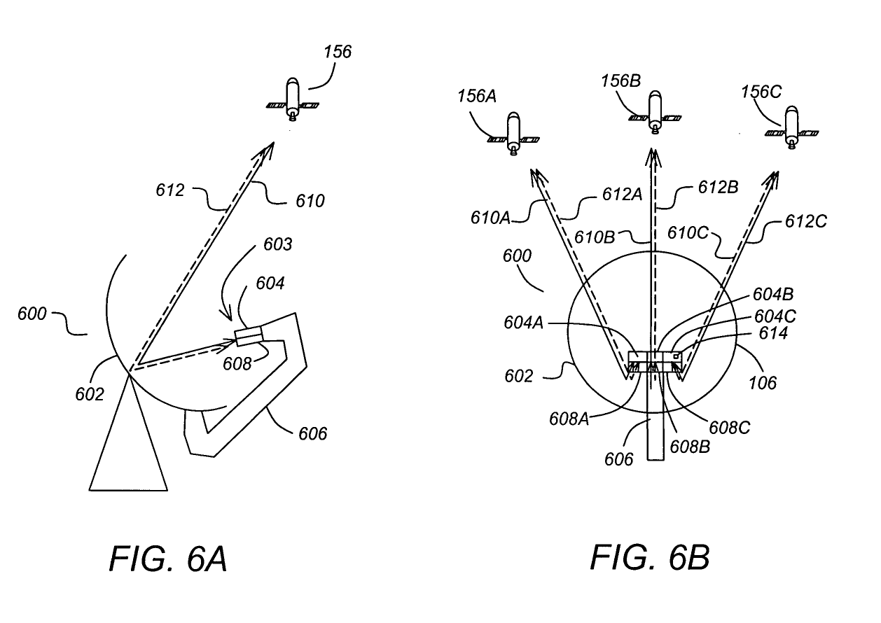

FIGS. 6A and 6B are diagrams of one embodiment of an integrated uplink/downlink antenna 600. In this embodiment, the integrated antenna 600 comprises a reflector and an offset dual-purpose feed 603 supported by brace 606. The dual purpose feed 603 includes a bank of low noise block converters 604A-604C for receiving downlinked signals from each of the respective satellites 156A-156C, but also comprises an adjacent bank of RF emitters 608A-608C for transmitting information to the respective satellites 156A-156C. In this configuration, the integrated uplink/downlink antenna provides a downlink antenna 106 (using LNBs 604A-604C, brace 606 and shared reflector 602) and an uplink antenna 454 (using RF emitters 608A-608C), brace 606, and shared reflector 602). The downlink antenna includes a downlink antenna boresight 610. For antennas 600 having multiple LNBs 604 for switchably receiving signals from multiple satellites 156A-156C, the downlink antenna includes multiple downlink antenna boresights 610A-610C. Similarly, the uplink antenna includes an uplink antenna boresight 612, and for antennas 600 having multiple RF emitters 608A-608C, multiple uplink antenna boresights 612A-612C.

In the illustrated embodiment, the LNBs 604A-604C are adjacent the emitters 608A-608C, so that the STB 110 cannot receive the downlink signal (and hence a media program) unless the integrated uplink/downlink antenna 600 is also configured to transmit the backchannel uplink signal to the respective satellites 156A-156C. Note that in this configuration, the boresights 610, 612 of the downlink antenna components are physically aligned to be effectively co-linear or spatially coaxial with the boresights of the uplink antenna components by virtue of their adjacency to one another other. Such alignment can also be accomplished electrically, for example, by use of focal plane array technologies. The downlink 106 and uplink 454 antennas may also be separate structures that do not share the same reflector 602 or brace 606, such as is illustrated in FIG. 4.

The dual-purpose feed 603 can be designed so as to prevent the subscriber from disabling the uplink functionality. For example, the dual purpose feed 603 can itself be integrated into a single module, each sharing a common power supply and each sharing a common conductor for the transfer of information to and from the STB 110. To implement this feature, data going from the LNBs 604 can be time, frequency, or code division multiplexed with information passing from the STB 110 to the emitters 608.

The integrated antenna 600 may also comprise one or more repeaters 614, that return a signal when prompted by a signal transmitted to the downlink antenna 106. This signal can be relayed by the satellite 156 to the broadcaster segment 401, and this information can be used to determine if the uplink antenna has been disabled, and to enable the reception of media programs by the receiver station 104, or disable such reception the uplink antenna is not operational. Such repeaters 614 can be used to assure that the antenna is properly aligned.

Other designs are possible. For example, the uplink antenna may have an emitter 608 that is separate from the LNB 604, and may even have a separate reflector. Also, the uplink and downlink antennas may be of a completely different design (including manually steerable horns or focal plane arrays). Further, while the foregoing implement communications back to the satellite 156 that is currently transmitting the media programs, that is not necessarily the case. Information can be uplinked via the backchannel to the headend 405 via other satellites as well. For example, LNB 608A can be used to receive information from satellite 156A, while emitter 606B concurrently transmits uplink information to satellite 156B.

The communications subsystem 450 can also be practiced in other embodiments. For example, although the primary objective of the communication subsystem 450 is to transmit backchannel information using simplex communication techniques, the communications subsystem 450 can also be configured to accept downlinked information and to support duplex communications as well.

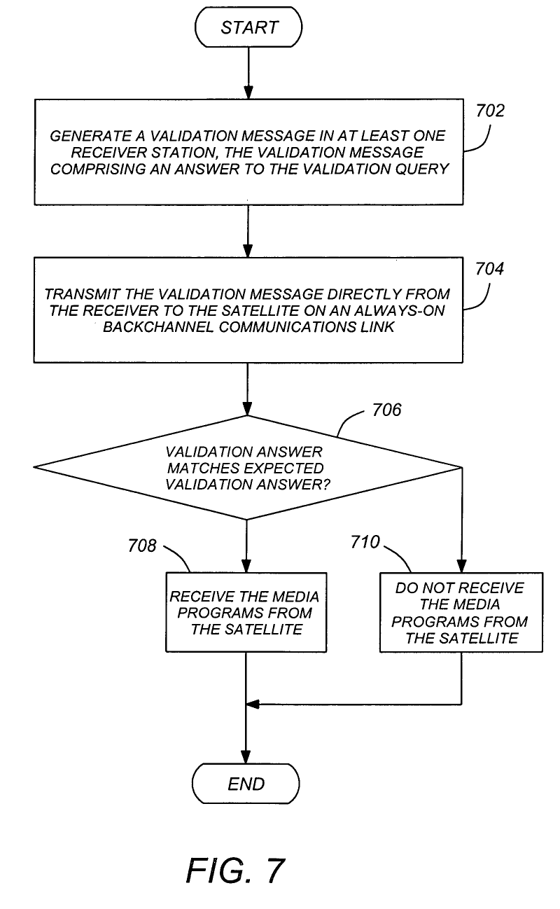

FIG. 7 is a diagram of one technique for preventing fraudulent reception of media programs using always-on backchannel messaging. In block 702, a validation message is generated in a receiver station 104 in response to a validation query. In block 704, the validation message is transmitted directly from the receiver to the satellite 156 (and thereafter to the broadcast segment 401 via the always-on backchannel communications link). The answer in the validation message is compared to an expected answer as shown in block 706. If the received validation answer matches an expected validation answer, the receiver station 104 is permitted to receive media programs from the broadcast segment 401 via the satellite 156, as shown in block 708. If not, reception of the media programs is not permitted, as shown in block 710.

The validation query can be generated in the receiver station 104 or by the broadcast segment 410 and transmitted to the receiver station 104. In cases where the validation message is generated in the receiver station 104 itself, the trigger may be a timer, an internally generated prompt, an error message (indicating a software or hardware fault) or an indication that the same element of the receiver station 104 has been or is being tampered with.

For example, in one embodiment, the validation query is generated in the receiver station 104 itself, and is generated in response to an indication within the receiver station 104 that a hacker is trying to glitch the processor clock in the CAM 206 in order to determine the nature of the programming instructions stored therein. In response to this trigger, the receiver station 104 can generate a message indicating the state of the CAM 206 and/or the STB 110. This “state” information can include, for example, the value of a number of flags and/or one or all of the software instructions resident in the CAM 206 and/or the STB 110. This information can be forwarded via the backchannel to the broadcaster segment 401, compared with the expected status of the flags and/or expected value of the software instructions, and based on that determination, the broadcast segment can send a message to the receiver station 104 to disable the receiver station 104 from receiving any further media programs, or to put the receiver station 104 into a “safe” mode to provide minimal service while preventing further tampering. Thus, if the software resident in the receiver station 104 (the STB 110 and/or the CAM 206) has been hacked into and altered, the broadcaster segment 401 can detect this compromise and disable the STB 110 or CAM 206. The hacker cannot disable this feature by simply unplugging the PSTN connection, since no such PSTN connection is used for the backchannel. Further, if a validation message is not received from the receiver station 104 when it is expected, the broadcaster segment 401 can take appropriate action, including the transmission of a warning message, placing the receiver station 104 in the safe mode, or disabling the STB 110 and/or CAM 206 altogether.

In some circumstances, it is desirable for the information transmitted via the backchannel to the headend 405 to be secure. In such instances, the information itself may be hashed by a processor either in the CAM 206 or the STB 110 before transmission to the headend 405. In such circumstances, the headend 405 compares a hash of the expected instructions with the message received from the receiver station 104. The information may also be encrypted by a shared secret, a public/private key pair, or similar technique.

The instructions resident in the STB 110 and/or the CAM 206 might also have become compromised for reasons other than hacking. For example, it is possible that software glitches or power surges may effect changes in such software. In such cases, it may be more appropriate for the broadcaster segment 401 to respond to the determination that the software instructions resident in the STB 110 and/or the CAM 206 are not the approved or expected instructions by simply downloading the approved replacement software instructions. Such instructions may include additional features or traceable instructions that permit the broadcaster segment 401 to troubleshoot the disparity in the software instructions or to trace the source of the hacking that has been performed on the software. For example, if it has been determined that a particular set of software instructions have been hacked and the hack has a particular signature, the always-on backchannel can be used to monitor and slow spread of that hacked software by identifying the ultimate source and primary distributors of the hack.

The validation query may also be a challenge generated by the broadcaster segment 401 and transmitted to the receiver station 104. The receiver station 104 operates on the challenge using an algorithm known to the broadcaster segment 401 to generate the answer, and transmits the answer to the broadcaster segment 401. The broadcaster segment 401 generates an expected answer using the known algorithm and compares the result to the received result to determine whether the receiver station 104 should be disabled from receiving any further media programs.

The disablement of the receiver station 104 from receiving any further media programs can be accomplished in a number of ways. For example, this may be accomplished by ceasing the transmission of EMMs to the receiver station 104 scheduled to be disabled. Or, this may be accomplished by the transmission of disabling flag, message, or instruction.

Digital video recorders (DVRs) 462 are becoming increasingly popular. Like ordinary video tape recorders (VTRs), DVRs 462 allow the user to record and playback media programs, but unlike VTRs, DVRs 462 allow “live pause” functionality, wherein the user may pause the display of a program currently being viewed, and return later to view the program from that point forward. This is implemented by storing the media program while the “pause” function is enabled, and replaying the recorded (and thus, delayed) media program while concurrently recording the live broadcast from that point forward when the user selects “play”. DVRs 462 also permit downloading of media programs for later viewing. Such pre-loaded media programs can be paid for on a per-view, a per-multiple view, per-unlimited view basis. Restrictions can also be placed on the playback of the pre-recorded media programs, such as limiting the number of copies, or only permitting copies to be made to a VTR.

One of the difficulties with such DVRs 462 is how to manage and control the recording, viewing, copying, and/or archiving of media programs. In the past, the viewing of recorded media programs was controlled (1) storing a permitted number of replays in the receiver station 104 (typically the CAM 206), and designing software internal to the STB 110 or CAM 206 to permit only the stored number of replays, or (2) permitting the subscriber to replay the media program on an impulse, and storing the number of replays for later transmission to the headend 405, (3) allowing the user as many replays as they would like for a limited period of time.

The problem with these solutions is that they are subject to compromise and abuse. For example, the STB 110 or CAM 206 could be hacked, and the logic limiting or recording the number of replays could be bypassed or otherwise modified, or the permitted number of replays or actual replays could be modified. The procedures described above substantially limit the ability of the hacker to modify the logic or the number of stored replays, as such information could be transmitted at any time to the headend 405. In intermittent backchannel systems, the hacker could set the number of plays at any desired value, so long as when the STB 110 dialed up the headend 405 again, the stored values were set back to the a value that the headend 405 expected. With an always-on backchannel, the hacker can never be sure when the information will be returned to the headend 405, making it more difficult to make any such changes. Further, since the backchannel does not rely on the convenience of a telephone jack and the backchannel components are integrated with the components needed to receive the media programs via the downlink signal, the headend 405 may reasonably terminate service to a particular receiver station 104 if no returned message is received. Such actions are not possible with landline dial up systems because too many legitimate subscribers are unwilling or unable to connect the phone jack to their STB 110.

Using the information obtained from the STB 110 on the backchannel, the headend 405 can take appropriate action, such as blocking further plays of the program, charging a different rate for subsequent viewings or offering to the subscriber additional related content which is related to this program. These rules can then be sent to the particular receiver and acted on accordingly.

The always-on backchannel has other DVR-related benefits. For example, the always-on back channel can be used to transmit information while the media program is being replayed by the DVR 462. This would severely limit the effectiveness of a hacker's ability to modify the number of replays (permitted or actually performed), because the always-on backchannel can be used to approve, in advance, any action taken with regard to the storage, playback, or archiving any desired media program. Even wireless dial-up backchannels are inadequate for obtaining approval before recording a media program . . . connection delays are such that the first 30 seconds or so of the program sought to be recorded would be lost. The always-on backchannel eliminates these delays and allows the head end 405 to respond quickly to requests and to exercise much tighter control over the DVR 462.

The always-on backchannel can also be used for other useful purposes. For example, live media programs are often recorded by users for later viewing and archival purposes, and in many cases, these recordings include many advertisements and commercials. Since such programs may be viewed many months or years after the recording was originally made, such recordings include commercials that are no longer of interest to any consumer. However, using the always-on backchannel, the STB 110 may sense the beginning and end of commercials in the archived recording, and transmit information to the headend 405, allowing the headend 405 to transmit substitute commercials or advertisements to the STB 110 for presentation to the viewer in lieu of the commercials or advertisements originally presented.

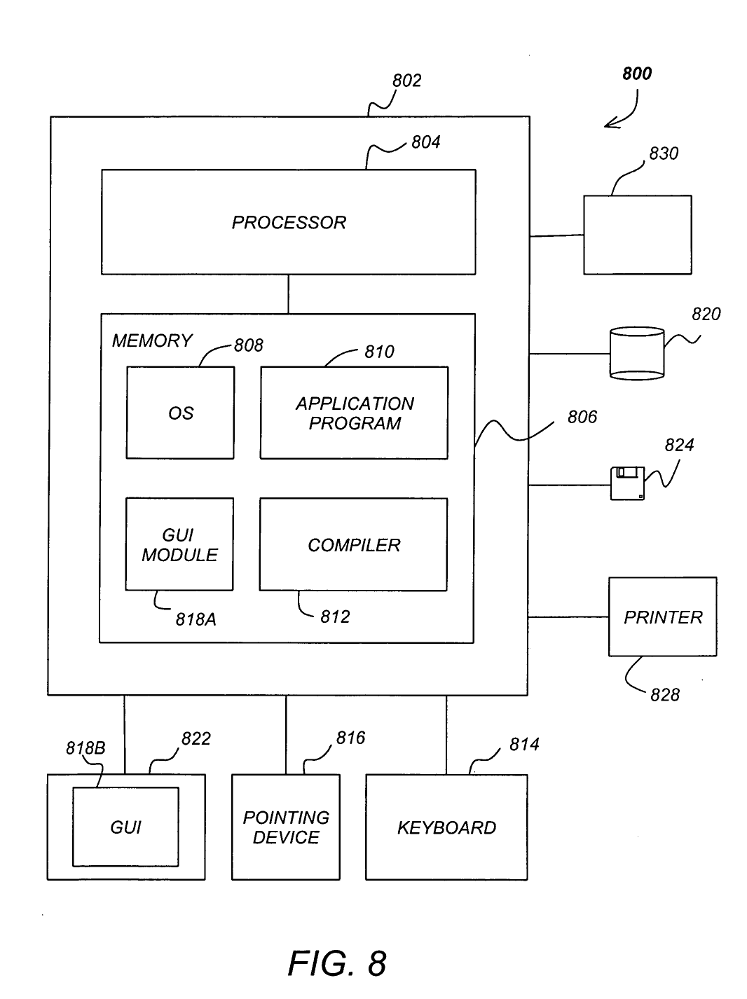

FIG. 8 illustrates an exemplary computer system 800 that could be used to implement the present invention. The computer 802 comprises a processor 804 and a memory, such as random access memory (RAM) 806. The computer 802 is operatively coupled to a display 822, which presents images such as windows to the user on a graphical user interface 818B. The computer system 802 may be coupled to other devices, such as a keyboard 814, a pointing device 816, a printer 828, etc. Of course, those skilled in the art will recognize that any combination of the above components, or any number of different components, peripherals, and other devices, may be used with the computer 802.

Generally, the computer 802 operates under control of an operating system 808 stored in the memory 806, and interfaces with the user to accept inputs and commands and to present results through a graphical user interface (GUI) module 818A. Although the GUI module 818A is depicted as a separate module, the instructions performing the GUI functions can be resident or distributed in the operating system 808, the computer program 810, or implemented with special purpose memory and processors. The computer 802 also implements a compiler 812 which allows an application program 810 written in a programming language such as COBOL, C++, FORTRAN, or other language to be translated into processor 804 readable code. After completion, the application 810 accesses and manipulates data stored in the memory 806 of the computer 802 using the relationships and logic that was generated using the compiler 812. The computer 802 also optionally comprises an external communication device such as a modem, satellite link, Ethernet card, or other device for communicating with other computers.

In one embodiment, instructions implementing the operating system 808, the computer program 810, and the compiler 812 are tangibly embodied in a computer-readable medium, e.g., data storage device 820, which could include one or more fixed or removable data storage devices, such as a zip drive, floppy disc drive 824, hard drive, CD-ROM drive, tape drive, etc. Further, the operating system 808 and the computer program 810 are comprised of instructions which, when read and executed by the computer 802, causes the computer 802 to perform the steps necessary to implement and/or use the present invention. Computer program 810 and/or operating instructions may also be tangibly embodied in memory 806 and/or data communications devices 830, thereby making a computer program product or article of manufacture according to the invention. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present invention. For example, those skilled in the art will recognize that any combination of the above components, or any number of different components, peripherals, and other devices, may be used with the present invention.

### CONCLUSION

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for preventing fraudulent reception of media programs transmitted by a satellite via a forward channel link to a plurality of receiver stations, comprising the steps of.
generating a validation message in at least one of the receiver stations, the validation message comprising an answer to a validation query;
transmitting the validation message directly from the receiver to the satellite on an always-on backchannel communications link; and
receiving the media programs from the satellite only if the validation message matches an expected validation message.

2. The method of claim 1, wherein the validation query is generated by the at least one receiver station.

3. The method of claim 1, wherein the validation query is transmitted from the satellite.

4. The method of claim 1, wherein the at least one receiver station comprises a receiver and a removable conditional access module (CAM) having memory storing instructions for providing conditional access to the media programs, and validation message comprises one or more of the instructions.

5. The method of claim 4, further comprising the step of comparing the instructions to approved instructions to determine if the CAM has been hacked.

6. The method of claim 5, further comprising the step of disabling the CAM if the CAM has been hacked.

7. The method of claim 5, further comprising the step of downloading approved instructions into the CAM if the CAM has been hacked.

8. The method of claim 5, further comprising the step of loading traceable instructions into the CAM if the CAM has been hacked.

9. The method of claim 4 above, further comprising the step of comparing the instructions to expected instructions to determine if the CAM is defective.

10. The method of claim 1, wherein the one of the receiver stations comprises a receiver having a removable CAM having memory storing instructions for providing conditional access to the media programs and a processor for performing the media instructions, and validation message comprises an indication if the processor has been glitched.

11. The method of claim 10, wherein the receiver comprises a memory storing instructions for providing access to the media programs, and a processor for performing the instructions, and the validation comprises one or more of the instructions.

12. The method of claim 11, further comprising the step of comparing the instructions to approved instructions to determine if the receiver has been hacked.

13. The method of claim 11, further comprising the step of downloading approved instructions into the receiver if the receiver has been hacked.

14. The method of claim 11, further comprising the step of downloading traceable instructions into the receiver if the receiver has been hacked.

15. The method of claim 1, wherein the forward channel communications link and the backchannel communication link are spatially coaxial.

16. The method of claim 1, wherein the receiver station comprises an antenna having:
an downlink antenna, for receiving a downlink signal from the satellite;
a repeater, for generating a response signal from the downlink antenna; and
an uplink antenna substantially aligned with the downlink antenna, for transmitting response signal to the satellite.

17. The method of claim 1, wherein the receiver station comprises an integrated antenna including a downlink antenna and an uplink antenna, the downlink antenna having a downlink antenna boresight and the uplink antenna having an uplink antenna boresight, wherein the downlink antenna and the uplink antenna are integrated to substantially align the downlink antenna boresight with the uplink antenna boresight.

18. The method of claim 17, wherein the downlink antenna boresight is physically aligned with the uplink antenna boresight.

19. The method of claim 17, wherein the downlink antenna boresight is electrically aligned with the uplink antenna boresight.

20. The method of claim 1, wherein the backchannel communications link has a lower bandwidth than the forward channel link.

21. An apparatus for preventing fraudulent reception of media programs transmitted by a satellite via a forward channel link to a plurality of receiver stations, comprising:
means for generating a validation message in at least one of the receiver stations, the validation message comprising an answer to a validation query;
means for transmitting the validation message directly from the receiver to the satellite on an always-on backchannel communications link; and
means for receiving the media programs from the satellite only if the validation message matches an expected validation message.

22. The apparatus of claim 21, wherein the validation query is generated by the at least one receiver station.

23. The apparatus of claim 21, wherein the validation query is transmitted from the satellite.

24. The apparatus of claim 21, wherein the at least one receiver station comprises a receiver and a removable conditional access module (CAM) having memory storing instructions for providing conditional access to the media programs, and validation message comprises one or more of the instructions.

25. The apparatus of claim 24, further comprising means for comparing the instructions to approved instructions to determine if the CAM has been hacked.

26. The apparatus of claim 25, further comprising means for disabling the CAM if the CAM has been hacked.

27. The apparatus of claim 25, further comprising means for downloading approved instructions into the CAM if the CAM has been hacked.

28. The apparatus of claim 25, further comprising means for loading traceable instructions into the CAM if the CAM has been hacked.

29. The apparatus of claim 24, further comprising means for comparing the instructions to expected instructions to determine if the CAM is defective.

30. The apparatus of claim 21, wherein the one of the receiver stations comprises a receiver having a removable CAM having memory storing instructions for providing conditional access to the media programs and a processor for performing the media instructions, and validation message comprises an indication if the processor has been glitched.

31. The apparatus of claim 30, wherein the receiver comprises a memory storing instructions for providing access to the media programs, and a processor for performing the instructions, and the validation comprises one or more of the instructions.

32. The apparatus of claim 31, further comprising means for comparing the instructions to approved instructions to determine if the receiver has been hacked.

33. The apparatus of claim 31, further comprising means for downloading approved instructions into the receiver if the receiver has been hacked.

34. The apparatus of claim 31, further comprising the step of downloading traceable instructions into the receiver if the receiver has been hacked.

35. The apparatus of claim 21, wherein the forward channel communications link and the backchannel communication link are spatially coaxial.

36. The apparatus of claim 21, wherein the receiver station comprises an antenna having:
a downlink antenna, for receiving a downlink signal from the satellite;
a repeater, for generating a response signal from the downlink antenna; and
an uplink antenna substantially aligned with the downlink antenna, for transmitting response signal to the satellite.

37. The apparatus of claim 21, wherein the receiver station comprises an integrated antenna including a downlink antenna and an uplink antenna, the downlink antenna having a downlink antenna boresight and the uplink antenna having an uplink antenna boresight, wherein the downlink antenna and the uplink antenna are integrated to substantially align the downlink antenna boresight with the uplink antenna boresight.

38. The apparatus of claim 37, wherein the downlink antenna boresight is physically aligned with the uplink antenna boresight.

39. The apparatus of claim 37, wherein the downlink antenna boresight is electrically aligned with the uplink antenna boresight.

40. The apparatus of claim 21, wherein the backchannel communications link has a lower bandwidth than the forward channel link.

41. An apparatus for preventing fraudulent reception of media programs transmitted by a satellite via a forward channel link, comprising:
a receiver station comprising:
an uplink antenna;
a downlink antenna; and
a receiver, including:
a processor for generating a validation message, the validation message comprising an answer to a validation query;
a transmitter subsystem, coupled to the uplink antenna and the processor, the transmitter subsystem for transmitting the validation message directly from the receiver to the satellite on an always-on backchannel communications link; and
a receiver subsystem, coupled to the downlink antenna and the processor, the receiver subsystem for receiving the media programs from the satellite only if the validation message matches an expected validation message.

42. The apparatus of claim 41, wherein the validation query is generated by the at least one receiver station.

43. The apparatus of claim 41, wherein the validation query is transmitted from the satellite.

44. The apparatus of claim 41, wherein the receiver further comprises a removable conditional access module (CAM) having memory storing instructions for providing conditional access to the media programs, and validation message comprises one or more of the instructions.

45. The apparatus of claim 44, wherein the processor compares the instructions to approved instructions to determine if the CAM has been hacked.

46. The apparatus of claim 45, wherein the processor disables the CAM if the CAM has been hacked.

47. The apparatus of claim 45, wherein the processor downloads approved instructions into the CAM if the CAM has been hacked.

48. The apparatus of claim 45, wherein the processor loads traceable instructions into the CAM if the CAM has been hacked.

49. The apparatus of claim 44, wherein the processor compares the instructions to expected instructions to determine if the CAM is defective.

50. The apparatus of claim 41, wherein receiver comprises a removable CAM having memory storing instructions for providing conditional access to the media programs and a CAM processor for performing the media instructions, and validation message comprises an indication if the CAM processor has been glitched.

51. The apparatus of claim 41, wherein the forward channel communications link and the backchannel communication link are spatially coaxial.

52. The apparatus of claim 41, wherein the receiver station comprises an antenna having:
a downlink antenna, for receiving a downlink signal from the satellite;
a repeater, for generating a response signal from the downlink antenna; and
an uplink antenna substantially aligned with the downlink antenna, for transmitting response signal to the satellite.

53. The apparatus of claim 41, wherein the receiver station comprises an integrated antenna including a downlink antenna and an uplink antenna, the downlink antenna having a downlink antenna boresight and the uplink antenna having an uplink antenna boresight, wherein the downlink antenna and the uplink antenna are integrated to substantially align the downlink antenna boresight with the uplink antenna boresight.

54. The apparatus of claim 53, wherein the downlink antenna boresight is physically aligned with the uplink antenna boresight.

55. The apparatus of claim 53, wherein the downlink antenna boresight is electrically aligned with the uplink antenna boresight.
